(19) United States
(12) Patent Application Publication
(10) Pub. No.: US 2014/0003494 A1
(43) Pub. Date: Jan. 2, 2014

(54) DEVICE, SYSTEM AND METHOD OF VIDEO ENCODING

(71) Applicant: Yaniv Frishman, Kiryat Ono (IL)

(72) Inventor: Yaniv Frishman, Kiryat Ono (IL)

(21) Appl. No.: 13/976,141

(22) PCT Filed: Jun. 8, 2012
(86) PCT No.: PCT/US2012/041646

§ 371 Date: Jun. 26, 2013

Related U.S. Application Data
(60) Provisional application No. 61/583,349, filed on Jan. 5, 2012.

(51) Int. Cl. H04N 7/26

(52) U.S. Cl. CPC H04N 19/00133
USPC 375/240.02

(57) ABSTRACT

Some demonstrative embodiments include devices, systems and/or methods of video encoding. For example, a device may include an encoding selector to control a block encoder to encode current video data of at least one pixel block of a current video frame, the encoding selector is to select between a first encoding mode causing the block encoder to encode the current video data into an encoded block to be provided to a decoder, and a second encoding mode allowing the block encoder to generate an indication to indicate to the decoder that the current video data is to be decoded using video data decoded from a previous video frame, wherein the encoding selector is to select between the first and second encoding modes without using previous video data of the pixel block of the previous video frame.

### CROSS REFERENCE

This application claims the benefit of and priority from U.S. Provisional Patent application No. 61/583,349, entitled “Techniques for Advanced Video Coding (AVC)”, filed Jan. 5, 2012, the entire disclosure of which is incorporated herein by reference.

### BACKGROUND

Wireless communication has rapidly evolved over the past decades. Even today, when high performance and high bandwidth wireless communication equipment is made available, there is demand for even higher performance at a higher bandwidth.

Video signals may be generated by various video sources, for example, a computer, a game console, a Video Cassette Recorder (VCR), a Digital-Versatile-Disc (DVD), or any other suitable video source.

In many cases, it may be desired to place a video destination, for example, a screen or a projector, at a location in a relatively short distance, e.g., one or more meters, from the video source. This trend is becoming more common as flat-screen displays, e.g. plasma or Liquid Crystal Display (LCD) televisions are hung on a wall. Connection of such video destination to the video source through cables is generally undesired for aesthetic reasons and/or installation convenience. Thus, wireless transmission of the video signals from the video source to the screen is preferred.

The video source may include a transmitter to enable transmitting the video signals via a wireless medium, and the video destination may include a receiver to receive the video signals via the wireless medium.

Transmission of the video signals may be limited by one or more characteristics of the wireless medium, e.g., a bandwidth of the wireless medium, a data rate of the wireless medium, a range between the transmitter and the receiver and the like, and/or a power consumption of a device transmitting and/or receiving the video signals. For example, the data rate of the wireless medium may not be sufficient to transmit the video signals, e.g., if the video signals include a relatively large amount of video data, for example, High-Definition-Television (HDTV) data.

A compression method may be utilized to reduce the data size of the video data and to enable efficient transmitting of the video signal. The video source may include an encoder to encode the video data, and the video destination may include a decoder to decode the encoded video data.

The encoder may encode macroblocks of the video data. A macroblock may include a block of pixels of a video frame. In order to reduce the amount of transmitted data, the encoder may select to generate and transmit to the decoder a predicted skip (p-skip) macroblock, instead of an encoded macroblock. The p-skip macroblock may indicate to the decoder that previous video data of the macroblock in a previous video frame is to be used instead of current video data of the macroblock in a current video frame. The p-skip macroblock may have a reduced size, e.g. compared to the size of the encoded macroblock.

The encoder may determine to generate the p-skip macroblock based on a comparison between decoded video data corresponding to the previous video data of the macroblock and the current video data of the macroblock. Accordingly, the encoder may have to store the decoded video data corresponding to the previous video data to enable the comparison.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic flow chart illustration of a method of video encoding, in accordance with some demonstrative embodiments.

FIG. 3 is a schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may be used in conjunction with various devices and systems, for example, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a wired or wireless network, a wireless area network, a Wireless Video Area Network (WVAN), a Local Area Network (LAN), a Wireless LAN (WLAN), a Wireless Metropolitan Area Network (WMAN) communication system, a Personal Area Network (PAN), a Wireless PAN (WPAN), devices and/or networks operating in accordance with existing IEEE 802.11 standards (“the 802.11 standards”), e.g., including IEEE 802.11 (IEEE 802.11-2007: Standard for Information technology—Telecommunications and information exchange between systems—local and metropolitan area networks—Specific requirements. Part 11: Wireless LAN Medium Access Control (MAC) and Physical Layer (PHY) Specifications—June 2007), 802.11n (“IEEE 802.11n-2009—Amendment 5: Enhancements for Higher Throughput. IEEE-SA. 29 Oct. 2009”), 802.11 ac (“Very High Throughput <6 Ghz”), 802.11 task group ad (TGad) (“Very High Throughput 60 GHz”), and/or future versions and/or derivatives thereof, devices, and/or networks operating in accordance with IEEE 802.16 standards (“the 802.16 standards”), e.g., including 802.16 (IEEE-Std 802.16, 2004 Edition, Air Interface for Fixed Broadband Wireless Access Systems), 802.16d, 802.16e (IEEE-Std 802.16e, 2005 Edition, Physical and Medium Access Control Layers for Combined Fixed and Mobile Operation in Licensed Bands), 802.16f, 802.16m standards and/or future versions and/or derivatives thereof, devices, and/or networks operating in accordance with existing Wireless-Gigabit-Alliance (WGA) specifications (Wireless Gigabit Alliance, Inc (WiGig) MAC and PHY Specification Version 1.0, April 2010, Final specification) and/or WirelessHD™ specifications and/or future versions and/or derivatives thereof, devices and/or networks operating in accordance with existing WGA and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Global Navigation Satellite System (GNSS) device, a device having one or more internal antennas and/or external antennas, Digital Video Broadcast (DVB) devices or systems, multi-standard radio devices or systems, a wired or wireless handheld device (e.g. BlackBerry, Palm Treo), a Wireless Application Protocol (WAP) device, Bluetooth (BT) device, a Near Field Communication (NFC) device, or the like.

Some embodiments may be used in conjunction with one or more types of wireless communication signals and/or systems, for example, Radio Frequency (RF). Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Global Navigation Satellite System (GNSS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), Bluetooth (BT). Near Field Communication (NFC), or the like. Other embodiments may be used in various other devices, systems and/or networks.

It should be understood that some embodiments may be used in a variety of applications. Although embodiments of the invention are not limited in this respect, one or more of the methods, devices and/or systems disclosed herein may be used in WGA Wireless Display Extension (WDE) encoders, e.g., WGA WDE encoders utilizing an advanced video coding (AVC) packet format, or any other encoders utilizing any other format.

One or more of the methods, devices and/or systems disclosed herein may be used in various applications. e.g., civil applications, military applications, medical applications or any other suitable application. Some demonstrative embodiments disclosed herein may be used in the field of consumer electronics, for example, as part of any suitable television, video Accessories, Digital-Versatile-Disc (DVD), multimedia projectors. Audio and/or Video (A/V) receivers/transmitters, gaming consoles, video cameras, video recorders, and/or automobile A/V accessories. Some demonstrative embodiments disclosed herein may be used in the field of Personal Computers (PC), for example, as part of any suitable desktop PC, notebook PC, monitor, and/or PC accessories. Some demonstrative embodiments disclosed herein may be used in the field of professional A/V, for example, as part of any suitable camera, video camera, and/or A/V accessories. Some demonstrative embodiments disclosed herein may be used in the medical field, for example, as part of a medical video monitor, and/or medical accessories. Some demonstrative embodiments disclosed herein may be used in the field of security and/or surveillance, for example, as part of any suitable security camera, and/or surveillance equipment. Some demonstrative embodiments disclosed herein may be used in the fields of military, defense, digital signage, commercial displays, retail accessories, and/or any other suitable field or application.

The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may be used to provide a wireless service.

Some demonstrative embodiments may be used in conjunction with a wireless communication network communicating over a frequency band of 60 GHz. For example, the wireless communication network may include a communication protocol in accordance with the IEEE 802.11TGad specification, and/or the WGA specification. However, other embodiments may be implemented utilizing any other suitable wireless communication frequency bands, for example, an Extremely High Frequency (EHF) band (the millimeter wave (mmwave) frequency band), e.g., a frequency band within the frequency band of between 30 Ghz and 300 GHZ, a WLAN frequency band, a WPAN frequency band, a frequency band according to the WGA specification, and the like.

Some demonstrative embodiments include a device including an encoding selector to control a block encoder to encode current video data of at least one pixel block of a current video frame, the encoding selector is to select between a first encoding mode causing the block encoder to encode the current video data into an encoded block to be provided to a decoder, and a second encoding mode allowing the block encoder to generate an indication to indicate to the decoder that the current video data is to be decoded using video data decoded from a previous video frame, wherein the encoding selector is to select between the first and second encoding modes without using previous video data of the pixel block of the previous video frame.

In some demonstrative embodiments, the encoding selector is to select between the first and second encoding modes based on a comparison between a previous hash value of the previous video data and a current hash value of the current video data.

In some demonstrative embodiments, the encoding selector is to select the second encoding mode if the previous hash value is equal to the current hash value.

In some demonstrative embodiments, the encoding selector may include a memory to store the previous hash value.

In some demonstrative embodiments, the encoding selector is to select the second encoding mode only if the previous video data is identical to the current video data.

In some demonstrative embodiments, the indication may include a p-skip macroblock (MB).

In some demonstrative embodiments, the current video data of at least one pixel block may include video data of a frame slice including a plurality of macroblocks.

In some demonstrative embodiments, the block encoder is to encode the current video data using an intra prediction encoding.

In some demonstrative embodiments, the block encoder is to encode the current video data according to a Wireless Display Extension (WDE) Protocol Adaptation layer for Wireless-Gigabit-Alliance.

Some demonstrative embodiments include a system including a video encoder to select to encode current video data of at least one pixel block of a current video frame into an encoded block to be provided to a decoder, or to generate an indication to the decoder that the current video data is to be decoded using video data decoded from a previous video frame, the encoder is to select between encoding the current video data and generating the indication without using previous video data of the pixel block of the previous video frame; and a wireless communication unit to transmit the indication to the decoder.

In some demonstrative embodiments, the video encoder is to select between encoding the current video data and generating the indication based on a comparison between a previous hash value of the previous video data and a current hash value of the current video data.

In some demonstrative embodiments, the video encoder is to select to generate the indication if the previous hash value is equal to the current hash value.

In some demonstrative embodiments, the video encoder may include a block encoder; and an encoding selector to selectively cause the block encoder to encode the current video data or to allow the encoder to generate the indication based on the comparison between the current hash value and the previous hash value.

In some demonstrative embodiments, the encoding selector is to generate first control signal, if the previous hash value is equal to the current hash value, and a second control signal, if the previous hash value is not equal to the current hash value, and wherein the block encoder is to encode the current video data in response to the first control signal, and to generate the indication in response to the second control signal.

In some demonstrative embodiments, the encoding selector may include a memory to store the previous hash value.

In some demonstrative embodiments, the video encoder is to select to generate the indication only if the previous video data is identical to the current video data.

In some demonstrative embodiments, the indication may include a p-skip MB.

In some demonstrative embodiments, the current video data of at least one pixel block comprises video data of a frame slice including a plurality of macroblocks.

In some demonstrative embodiments, the video encoder is to encode the current video data using an intra prediction encoding.

In some demonstrative embodiments, the video encoder is to encode the current video data according to a WDE Protocol Adaptation layer for Wireless-Gigabit-Alliance.

Some demonstrative embodiments include a method of video encoding, the method may include, based on a comparison between a current hash value corresponding to current video data of at least one pixel block of a current video frame and a previous hash value corresponding to previous video data of the pixel block of a previous video frame, selecting whether to allow generating an indication to indicate to a decoder that the current video data is to be decoded using video data decoded from the previous video frame.

In some demonstrative embodiments, the method may include selecting to allow generating the indication if the previous hash value is equal to the current hash value.

In some demonstrative embodiments, the indication may include a p-skip MB.

In some demonstrative embodiments, the current video data of at least one pixel block may include video data of a frame slice including a plurality of macroblocks.

In some demonstrative embodiments, the method may include selecting to encode the current video data into an encoded block to be provided to the decoder, if the previous hash value is not equal to the current hash value.

Some demonstrative embodiments include a non-transitory product including a storage medium having stored thereon instructions that, when executed by a machine, result in, based on a comparison between a current hash value corresponding to current video data of at least one pixel block of a current video frame and a previous hash value corresponding to previous video data of the pixel block of a previous video frame, selecting whether to allow generating an indication to indicate to a decoder that the current video data is to be decoded using video data decoded from the previous video frame.

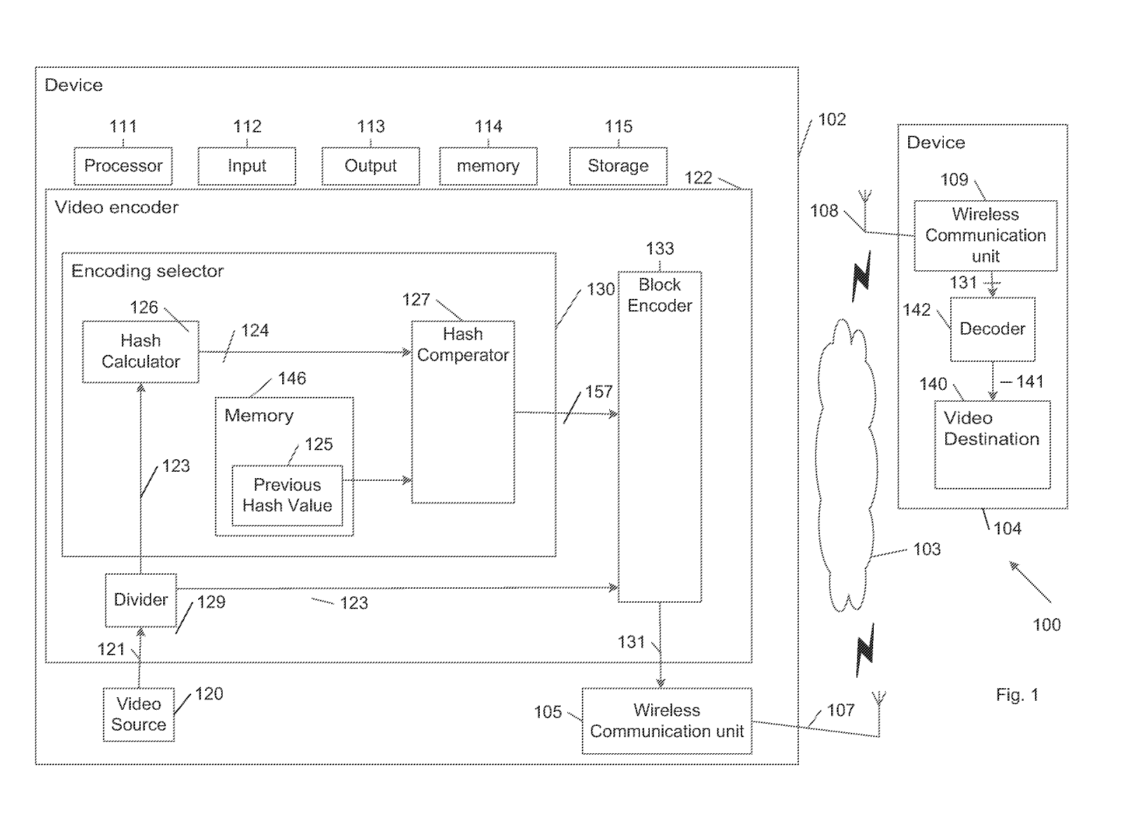

Reference is made to FIG. 1, which schematically illustrates a system 100, in accordance with some demonstrative embodiments.

In some demonstrative embodiments, system 100 may include one or more devices, e.g., a device 102 and a device 104, capable of communicating content, data, information and/or signals over a wireless communication medium 103. For example, device 102 may include a wireless communication unit 105 capable of communicating over wireless communication medium 103 via one or more antennas 107; and/or device 104 may include a wireless communication unit 109 capable of communicating over wireless medium 103 via one or more antennas 108.

In some demonstrative embodiments, wireless communication medium 103 may include one or more unidirectional and/or single-directional wireless channels, for example, a Radio Frequency (RF) channel, a WiFi channel, a Bluetooth channel, a cellular channel, and the like.

In some demonstrative embodiments, antennas 108 and/or 107 may include any type of antennas suitable for transmitting and/or receiving wireless communication video signals, blocks, frames, transmission streams, packets, messages and/or data. Types of antennas that may be used for antennas 108 and/or 107 may include but are not limited to internal antenna, dipole antenna, omni-directional antenna, a monopole antenna, an end fed antenna, a circularly polarized antenna, a micro-strip antenna, a diversity antenna, a phase array antenna and the like. In some embodiments, antennas 108 and/or 107 may implement transmit and receive functionalities using separate transmit and receive antenna elements. In some embodiments, antennas 108 and/or 107 may implement transmit and receive functionalities using common and/or integrated transmit/receive elements.

In some demonstrative embodiments, device 102 may include a video encoder 122 configured to encode video data 121, e.g., from a video source 120, to generate encoded video 131 to be transmitted to device 104. Video encoder 122 may enable device 102 to transmit video data 121, e.g., even when video data 121 includes a relatively large amount of data, e.g., HDTV video data.

In some demonstrative embodiments, video encoder 122 may include a WDE encoder, for example, an encoder configured according to a WDE Protocol Adaptation layer for WiGig. For example, encoder 122 may include a WGA WDE encoder utilizing an AVC packet format. In other embodiments, video encoder 122 may include any other encoder utilizing any other format.

In some demonstrative embodiments, video source 120 may include any suitable video software and/or hardware, for example, a portable video source, a non-portable video source, a Set-Top-Box (STB), a DVD, a digital-video-recorder, a game console, a PC, a portable computer, a Personal-Digital-Assistant, a Video Cassette Recorder (VCR), a video camera, a web camera, a built-in digital camera, a cellular phone, a television (TV) tuner, a photo viewer, a media player, a video player, a portable-video-player, a portable DVD player, an MP-4 player, a video dongle, a cellular phone, and the like. Video data 121 may include video data of any suitable video format. In one example, video data 121 may include HDTV video data e.g., in a Digital Video Interface (DVI) format, a High Definition Multimedia Interface (HDMI) format, a Video Graphics Array (VGA) format, a VGA DB-15 format, an Extended Graphics Array (XGA) format, and their extensions, or any other suitable video format.

In some demonstrative embodiments, wireless communication unit 105 and/or video encoder 122 may include or may be part of a wireless communication card, which may be attached to video source 102, externally or internally.

In some demonstrative embodiments, video source 120, wireless communication unit 105 and video encoder 122 may be implemented as part of a video source device 102, e.g., such that video source 120, wireless communication unit 105 and video encoder 122 are enclosed in a common housing, packaging, or the like. In other embodiments, wireless communication unit 105, video encoder 121 and/or video source 120 may be implemented as separate devices and/or units.

In some demonstrative embodiments, wireless communication unit 105 may transmit wireless communication signals including encoded video 131, and wireless communication unit 109 may receive the wireless communication signals including encoded video 131.

In some demonstrative embodiments, device 104 may include a decoder 142 configured to decode encoded video 131 and to generate video data 141, e.g., corresponding to video data 121.

In some demonstrative embodiments, device 104 may include a video destination 140 configured to handle video data 141 in any suitable manner, for example, a display or screen, e.g., a flat screen display, a Liquid Crystal Display (LCD), a plasma display, a back projection television, a television, a projector, a monitor, an audio/video receiver, a video dongle, and the like.

In some demonstrative embodiments, device 102 may include a portable or mobile computing device, for example, a laptop, a PDA, a cellular device, and the like, and device 104 may include a wireless display device.

In some demonstrative embodiments, video data 121 may include a sequence of two or more video frames. For example, video data 121 may include a predefined number of frames per second. For example, an HDTV camera may generate HDTV video data, which may include, for example, twenty-five frames per second.

In some demonstrative embodiments, video encoder 122 may include a divider 129 configured to divide a current video frame of video data 121 into one or more pixel blocks including current video data 123.

In some demonstrative embodiments, the phrase “pixel block” (also referred to as a “macroblock” (MB)) as used herein, may include a segment of a video frame including a number of pixels arranged in a grid of pixels. For example, the video frame may include a predefined number of pixels. e.g., 786,432 pixels, arranged in a rectangular grid of pixels, e.g. 1024 columns of pixels by 768 rows of pixels. The video frame may be divided into a plurality of rectangular blocks, e.g., such that each pixel block of the video frame may include, for example, a block of 16 rows by 16 columns, including 256 pixels of the video frame.

In some demonstrative embodiments, video encoder 122 may encode current video data 123 into an encoded block to be provided to decoder 142.

In some demonstrative embodiments, video encoder 122 may encode current video data 123 using a predefined encoding method. For example, video encoder 122 may utilize intra-prediction encoding. The intra-prediction encoding may utilize video data of the current video frame to encode the video frame. For example, the intra prediction method may utilize similar or equal segments in the current video frame to encode the current video frame.

In some demonstrative embodiments, video encoder 122 may selectively generate an indication to decoder 142, instead of encoding current video data 123. The indication may indicate that current video data 123 may be decoded using video data decoded from a previous video frame.

In some demonstrative embodiments, the indication may have a reduced size, e.g., compared to the size of the encoded block. For example, the indication may include a predefined value having a predefined size, e.g., a predefined fixed size code or the like. Accordingly, when possible, it may be preferable to transmit the indication instead of the encoded video data, e.g., in order to reduce the amount of video data to be transmitted via wireless communication medium 103.

In some demonstrative embodiments, the indication may include a predicted skip (p-skip) macroblock (MB). The phrase “p-skip macroblock”, as used herein, may include a predefined code or signal configured to indicate to decoder 142 that the current video data 123 may be decoded using video data decoded from a previous video frame.

In some demonstrative embodiments, video encoder 122 may be configured to select to encode current video data 123 into the encoded block, or to generate the indication to decoder 142. For example, based on the selection, video encoder 122 may generate encoded video 131 corresponding to current video data 123 including either the encoded block or the indication.

In some demonstrative embodiments, selecting to encode current video data 123 or to generate the indication based on a comparison between current video data 123 and previous video data of the pixel block in the previous video frame may require storing the previous video data, which may have a relatively large size.

In some demonstrative embodiments, video decoder 122 may select between encoding current video data 123 of the pixel block in the current video frame, and generating the indication, without using the previous video data of the pixel block in the previous video frame, e.g., as described below. Accordingly, video encoder 122 may not have to store the previous video data of the previous video frame.

In some demonstrative embodiments, video encoder 122 may select between encoding current video data 123 and generating the indication based on a comparison between a previous hash value 125 of the previous video data and a current hash value 124 of current video data 123, e.g. as described below.

In some demonstrative embodiments, the phrase “hash value”, as used herein with reference to particular data, may include a value representing the particular data and having a size lesser than a size of the particular data. For example, the hash value may include a code, a number, a bit string and/or the like, having a reduced predefined fixed size. The hash value may have a size, which is, for example, reduced by more than fifty percent. e.g., at least eighty percent, compared to the size of the particular data. For example, a size of hash values 124 and 125 may be about ten percent of the size of current video data 123.

In some demonstrative embodiments, the hash value may be calculated by any suitable hash function, for example, cyclic redundancy check (CRC) algorithm, secure hash algorithm (SHA), e.g., SHA-256, and/or the like.

In some demonstrative embodiments, the hash function may assign, e.g., with a relatively high statistical probability, equal hash values to equal data, and different hash values to different data. For example, the hash function may calculate a first hash value for first video data, and a second, e.g., equal, hash value for second video data, e.g., if the first and second video data are identical. The hash function may calculate a first hash value for first video data and a second, e.g., different, hash value for second video data. e.g., if the first and second video data are different.

In some demonstrative embodiments, video encoder 122 may be allowed generate the indication with respect to current video data 123, if current hash value 124 is equal to previous hash value 125. For example, video encoder 122 may generate the p-skip macroblock if current hash value 124 is equal to previous hash value 125.

In some demonstrative embodiments, current hash value 124 may be equal to previous hash value 125, for example, if current video data 123 and the previous video data are identical, e.g., due to the high statistical probability of the hash function.

Accordingly, selecting to allow generating the p-skip macroblock based on the comparison between current hash value 124 and previous hash value may result in allowing the p-skip macroblock, e.g., only if current video data 123 of the macroblock in the current video frame is identical to the previous video data of the macroblock in the previous video frame.

Therefore, it may be relatively efficient to utilize hash values 124 and 125 for the selection whether or not to generate the p-skip macroblock, e.g., when the video data in one or more macroblocks remains unchanged, e.g., static, between two or more video frames. For example, it may be efficient to utilize the hash values 124 and 125 for the selection, if video data 121 includes static video data in one or more macroblocks.

In some demonstrative embodiments, the selection, whether or not to generate the p-skip macroblock, based on the comparison of hash values 124 and 125, may be more beneficial when there is a large number of macroblocks and/or segments including static video data, e.g., if video data 121 is dynamic only in one or more relatively small parts of the video frame. Accordingly, video encoder 122 may be allowed to generate the p-skip macroblock based on the comparison between hash values 124 and 125 for almost all of the macroblocks in the video frame, e.g., except for macroblocks including the dynamic video data.

In one example, video data 121 may include two or more frames having a large number of macroblocks having static video data, e.g., without any changes, for a relatively long period of time. For example, video data 121 may represent a video image, which has few changes, e.g., a photo, an article, text document and the like. Accordingly, a relatively large portion of the current video frame may include static video data, e.g., except for a small portion of the current video frame having a few changes, e.g., a portion of the video image representing a mouse arrow, text being edited, and the like. Accordingly, the macroblocks of the static portion may include video data identical to the video data in a previous video frame. Therefore, hash values 124 and 125 may be equal for the macroblocks of the static portion, and video encoder 122 may be allowed to generate p-skip macroblocks corresponding to the macroblocks of the static portion. As a result, device 102 may transmit a relatively small amount of data. e.g., including only the p-skip macroblocks, with respect to the large static portion of the video image, which may increase the efficiency of the video compression and the utilization of wireless medium 103.

In some demonstrative embodiments, video encoder 122 may detect that an entire frame slice, which may include a plurality of macroblocks, in the current video frame may be static. In one example, video encoder 122 may include a WGA WDE encoder utilizing an AVC packet format enabling to encode a slice including a plurality of MBs. Video encoder 122 may calculate current hash value 124 corresponding to the entire frame slice, and encode the entire slice using a plurality of p-skip macroblocks, e.g., in the form of a “skip slice”, corresponding to the plurality of macroblocks of the frame slice.

In some demonstrative embodiments, video encoder 122 may include a block encoder 133 and an encoding selector 130 configured to control block encoder 133 to encode current video data 123.

In some demonstrative embodiments, encoding selector 130 may select between a first encoding mode causing block encoder 133 to encode current video data 123 into the encoded block, and a second encoding mode allowing block encoder 133 to generate the indication, e.g., the p-skip macroblock, corresponding to current video data 123. The encoding selector 130 may select between the first and second encoding modes without using the previous video data, e.g., as described below.

In some demonstrative embodiments, encoding selector 130 may include a hash calculator 126 configured to calculate current hash value 124 corresponding to current video data 123.

In some demonstrative embodiments, hash calculator 126 may calculate current hash value 124 by applying a predefined hash function to current video data 123, e.g., as described above.

In some demonstrative embodiments, encoding selector 130 may include a memory 146 configured to store previous hash value 125. Memory 146 may include a memory having a relatively small size suitable for storing previous hash value 125. Memory 125 may have a relatively reduced size, e.g., by ninety percent, compared to a size of a memory required to store the previous video data of the macroblock.

In some demonstrative embodiments, encoding selector 130 may store in memory 146 the current hash value 124, e.g., to be utilized as a previous hash value for a next video frame of video data 121.

In some demonstrative embodiments, encoding selector 130 may include a hash comparator 127 configured to compare between current hash value 124 and previous hash value 125 retrieved from memory 146. Hash comparator 127 may provide a comparator output 157 to block encoder 130 based on the comparison.

In some demonstrative embodiments, comparator output 157 may include a first control signal having a predefined value, e.g., zero, if current hash value 124 is not equal to previous hash value 125, e.g., when current video data 123 is not identical to the previous video data of the macroblock in the previous video frame.

In some demonstrative embodiments, comparator output 157 may include a second control signal having a predefined value, e.g., one, if current hash value 124 is equal to previous hash value 125, e.g., when current video data 123 is identical to the previous video data.

In some demonstrative embodiment, block encoder 133 may utilize the first encoding mode and may encode current video data 123 in response to the first control signal. For example, block encoder 133 may encode current video data 123 using intra-prediction encoding.

In some demonstrative embodiments, block encoder 133 may be allowed to generate the indication instead of encoding current video data 123 in response to the second control signal. For example, block encoder 133 may generate the p-skip macroblock.

In some demonstrative embodiments, block encoder 133 may select to utilize the first encoding mode and may encode current video data 123, e.g., even if block encoder 133 receives the second control signal. For example, block encoder 133 may encode current video data 123 when the previous video data has low quality, e.g., to improve the quality of the encoded block of current video data 123.

In some demonstrative embodiments, devices 102 and/or 104 may include, or may be included as part of, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a STB, a BD player, a BD recorder, a DVD player, a HD DVD player, a DVD recorder, a HD DVD recorder, a PVR, a broadcast HD receiver, a video source, an audio source, a video sink, an audio sink, a stereo tuner, a broadcast radio receiver, a flat panel display, a PMP, a DVC, a digital audio player, a speaker, an audio receiver, a gaming device, an audio amplifier, a data source, a data sink, a DSC, a media player, a Smartphone, a television, an LCD display, a LED display, a plasma display, a digital projector, a wireless projector, a laser projector, a music player, or the like.

In some demonstrative embodiments, device 102 may include, for example, one or more of a processor 111, an input unit 112, an output unit 113, a memory unit 114, and a storage unit 115. Device 102 may optionally include other suitable hardware components and/or software components. In some embodiments, some or all of the components of device 102 may be enclosed in a common housing or packaging, and may be interconnected or operably associated using one or more wired or wireless links. In other embodiments, components of device 102 may be distributed among multiple or separate devices or locations.

Processor 111 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 111 executes instructions, for example, of an Operating System (OS) of device 102, and/or of one or more suitable applications.

Input unit 112 includes, for example, a keyboard, a keypad, a mouse, a touch-pad, a track-ball, a stylus, a microphone, or other suitable pointing device or input device. Output unit 113 includes, for example, a monitor, a screen, a flat panel display, a Cathode Ray Tube (CRT) display unit, a Liquid Crystal Display (LCD) display unit, a plasma display unit, one or more audio speakers or earphones, or other suitable output devices.

Memory unit 114 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 115 includes, for example, a hard disk drive, a floppy disk drive, a Compact Disk (CD) drive, a CD-ROM drive, a DVD drive, or other suitable removable or non-removable storage units. Memory unit 114 and/or storage unit 115, for example, may store data processed by device 102.

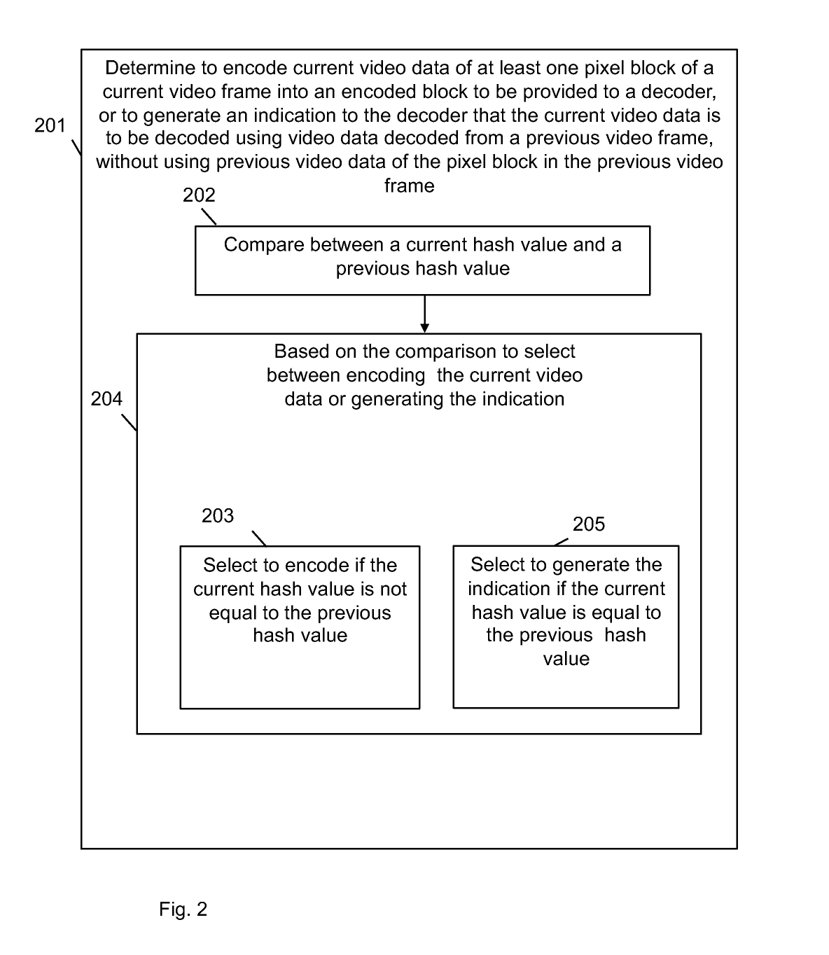

Reference is made to FIG. 2, which schematically illustrates a method of video encoding, in accordance with some demonstrative embodiments. In some embodiments, one or more of the operations of the method of FIG. 2 may be performed by any suitable system, e.g. system 100 (FIG. 1), a device, e.g., device 102 (FIG. 1), and/or a video encoder, e.g. video encoder 122 (FIG. 1).

As indicated at block 201, the method may include determining to encode current video data of at least one pixel block of a current video frame into an encoded block to be provided to a decoder, or to generate an indication to the decoder that the current video data is to be decoded using video data decoded from a previous video frame. Determining whether to encode the video data or to transmit the indication may be performed, for example, without using previous video data of the pixel block in the previous video frame. For example, video encoder 122 (FIG. 1) may determine to encode current video data 123 (FIG. 1) or to generate the indication to encoder 142 (FIG. 1) without using the previous video data, e.g., as described above.

As indicated at block 202, determining to encode the current video data or to generate the indication may include comparing between a current hash value corresponding to the current video data and a previous hash value corresponding to previous video data. For example, video encoder 122 (FIG. 1) may compare between current hash value 124 and previous hash value 125 (FIG. 1), e.g., as described above.

As indicated at block 204, determining to encode the current video data or to generate the indication may include selecting, based on the comparison, between encoding the current video data and generating the indication. For example, video encoder 122 (FIG. 1) may select, based on the comparison between hash values 124 and 125, to encode current image data 123 (FIG. 1) to be provided to decoder 142 (FIG. 1) or to generate the p-skip macroblock, e.g., as described above.

As indicated at block 203, the method may include selecting to encode the current video data into the encoded block, if the previous hash value is not equal to the current hash value. For example, video encoder 122 (FIG. 1) may select to encode current image data 123 (FIG. 1) if previous hash value 125 is not equal to current hash value 124 (FIG. 1), e.g., as described above.

As indicated at block 205, the method may include selecting to generate the indication, if the previous hash value is equal to the current hash value. For example, video encoder 122 (FIG. 1) may select to generate the p-skip macroblock if previous hash value 125 (FIG. 1) is equal to current hash value 124 (FIG. 1). e.g., as described above.

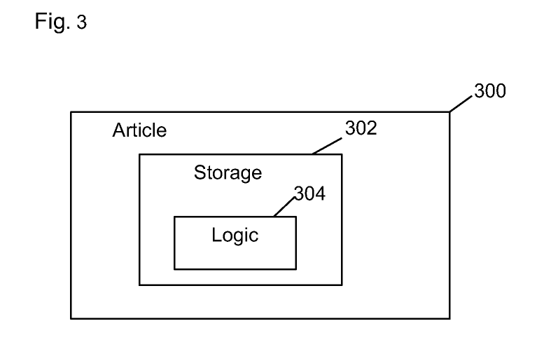

Reference is made to FIG. 3, which schematically illustrates an article of manufacture 300, in accordance with some demonstrative embodiments. Article 300 may include a non-transitory machine-readable storage medium 302 to store logic 304, which may be used, for example, to perform at least part of the functionality of video encoder 122 (FIG. 1) and/or to perform one or more operations of the method of FIG. 2. The phrase “non-transitory machine-readable medium” is directed to include all computer-readable media, with the sole exception being a transitory propagating signal.

In some demonstrative embodiments, article 300 and/or machine-readable storage medium 302 may include one or more types of computer-readable storage media capable of storing data, including volatile memory, non-volatile memory, removable or non-removable memory, erasable or non-erasable memory, writeable or re-writeable memory, and the like. For example, machine-readable storage medium 302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM). Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g. a modem, radio or network connection.

In some demonstrative embodiments, logic 304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A device comprising:
an encoding selector to control a block encoder to encode current video data of at least one pixel block of a current video frame, said encoding selector is to select between a first encoding mode causing said block encoder to encode said current video data into an encoded block to be provided to a decoder, and a second encoding mode allowing said block encoder to generate an indication to indicate to said decoder that said current video data is to be decoded using video data decoded from a previous video frame, wherein said encoding selector is to select between said first and second encoding modes without using previous video data of said pixel block of said previous video frame.

2. The device of claim 1, wherein said encoding selector is to select between said first and second encoding modes based on a comparison between a previous hash value of said previous video data and a current hash value of the current video data.

3. The device of claim 2, wherein said encoding selector is to select the second encoding mode if the previous hash value is equal to the current hash value.

4. The device of claim 1, wherein said encoding selector comprises a memory to store said previous hash value.

5. The device of claim 1, wherein said encoding selector is to select said second encoding mode only if said previous video data is identical to the current video data.

6. The device of claim 1, wherein said indication comprises a p-skip macroblock (MB).

7. The device of claim 1, wherein the current video data of at least one pixel block comprises video data of a frame slice including a plurality of macroblocks.

8. The device of claim 1, wherein said block encoder is to encode said current video data using an intra prediction encoding.

9. The device of claim 1, wherein said block encoder is to encode said current video data according to a Wireless Display Extension (WDE) Protocol Adaptation layer for Wireless-Gigabit-Alliance.

10. A system comprising:
a video encoder to select to encode current video data of at least one pixel block of a current video frame into an encoded block to be provided to a decoder, or to generate an indication to said decoder that said current video data is to be decoded using video data decoded from a previous video frame, said encoder is to select between encoding the current video data and generating the indication without using previous video data of said pixel block of said previous video frame; and
a wireless communication unit to transmit said indication to said decoder.

11. The system of claim 10, wherein said video encoder is to select between encoding the current video data and generating the indication based on a comparison between a previous hash value of said previous video data and a current hash value of the current video data.

12. The system of claim 11, wherein said video encoder is to select to generate said indication if the previous hash value is equal to the current hash value.

13. The system of claim 11, wherein said video encoder comprises:
a block encoder; and
an encoding selector to selectively cause said block encoder to encode said current video data or to allow said encoder to generate said indication based on the comparison between said current hash value and the previous hash value.

14. The system of claim 13, wherein said encoding selector is to generate first control signal, if the previous hash value is equal to the current hash value, and a second control signal, if the previous hash value is not equal to the current hash value, and wherein said block encoder is to encode said current video data in response to said first control signal, and to generate said indication in response to said second control signal.

15. The system of claim 13, wherein said encoding selector comprises a memory to store said previous hash value.

16. The system of claim 10, wherein said video encoder is to select to generate said indication only if said previous video data is identical to the current video data.

17. The system of claim 10, wherein said indication comprises a p-skip macroblock (MB).

18. The system of claim 10, wherein the current video data of at least one pixel block comprises video data of a frame slice including a plurality of macroblocks.

19. The system of claim 10, wherein said video encoder is to encode said current video data using an intra prediction encoding.

20. The system of claim 10, wherein said video encoder is to encode said current video data according to a Wireless Display Extension (WDE) Protocol Adaptation layer for Wireless-Gigabit-Alliance.

21. A method of video encoding comprising:
based on a comparison between a current hash value corresponding to current video data of at least one pixel block of a current video frame and a previous hash value corresponding to previous video data of said pixel block of a previous video frame, selecting whether to allow generating an indication to indicate to a decoder that said current video data is to be decoded using video data decoded from said previous video frame.

22. The method of claim 21 comprising selecting to allow generating said indication if the previous hash value is equal to the current hash value.

23. The method of claim 21, wherein said indication comprises a p-skip macroblock (MB).

24. The method of claim 21, wherein the current video data of at least one pixel block comprises video data of a frame slice including a plurality of macroblocks.

25. The method of claim 21 comprising selecting to encode said current video data into an encoded block to be provided to said decoder, if the previous hash value is not equal to the current hash value.

26. A non-transitory product including a storage medium having stored thereon instructions that, when executed by a machine, result in:
based on a comparison between a current hash value corresponding to current video data of at least one pixel block of a current video frame and a previous hash value corresponding to previous video data of said pixel block of a previous video frame, selecting whether to allow generating an indication to indicate to a decoder that said current video data is to be decoded using video data decoded from said previous video frame.

27. The product of claim 26, wherein said instructions result in selecting to allow generating said indication if the previous hash value is equal to the current hash value.

28. The product of claim 26, wherein said indication comprises a p-skip macroblock (MB).

29. The product of claim 26, wherein said instructions result in selecting to encode said current video data into an encoded block to be provided to said decoder, if the previous hash value is not equal to the current hash value.
